(19) United States
(12) Patent Application Publication
(10) Pub. No.: US 2011/0037396 A1
(43) Pub. Date: Feb. 17, 2011

(54) LIGHT EMITTING DIODE MODULE AND DRIVING METHOD THEREOF

(75) Inventors: Feng-Wei Chien, Taipei County (TW); Tsung-Hau Chang, Hsinchu City (TW); Chin-Hsun Hsu, Taipei County (TW); Kuo-Ching Hsu, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/603,576

(22) Filed: Oct. 21, 2009

(30) Foreign Application Priority Data
Aug. 12, 2009 (TW) 98127119

(51) Int. Cl. H05B 37/02

(52) U.S. Cl. 315/185 R

(57) ABSTRACT

A light emitting diode module having a plurality of LED strings is provided. The light emitting diode module includes a voltage generating loop, a light tuner, a voltage selector, and a voltage storage and comparison circuit. The voltage generating loop generates a system voltage according to a pulse modulation control signal. The light tuner receives a light tuning signal and turns on or off the LED strings accordingly. The voltage selector selects one of terminal voltages of terminals of the LED strings coupled to the light tuner for generating a selection voltage. The voltage storage and comparison circuit generates an error voltage by comparing the selection voltage and a reference voltage. The voltage storage and comparison circuit stores the error voltage temporarily and provides the temporarily stored error voltage as the pulse modulation control signal.

### CROSS-REFERENCE TO RELATED APPLICATION

This application claims the priority benefit of Taiwan application serial no. 98127119, filed on Aug. 12, 2009. The entirety of the above-mentioned patent application is hereby incorporated by reference herein and made a part of specification.

### BACKGROUND OF THE INVENTION

1. Field of the Invention

The invention generally relates to a light emitting diode (LED) module, and more particularly, to a light tuning method of an LED module.

2. Description of Related Art

In recent years, due to technological advances of fabricating process related to the LED module, applications of the LED are highly extended. Besides the indicating light, the LED is also applied to the display panel, the backlight module, or the illumination lamp. Moreover, the application of the LED is a subject matter related to environmental protection, so that the LED is one of the most popular electronic products in the current market.

In the LED module, in view of the system side thereof, it usually has a light tuner to provide the function of tuning brightness of the LED module. Referring to FIG. 1, FIG. 1 is a conventional LED module 100. The LED module 100 includes a voltage converter 110, a pulse signal modulator 120, a comparator 130, a voltage selector 140, a light tuner 150, a current driving device 160, and a plurality of LED strings 171 to 173. Wherein, the voltage converter 110 receives an input voltage VIN and generates a system voltage VOUT to drive the LED strings 171 to 173 according to a pulse signal PWS. The pulse signal PWS is generated by the pulse signal modulator 120 according to an error voltage ERR. The error voltage ERR is obtained by comparing a selection voltage SEL and a reference voltage VREF.

The light tuner 150 is formed by a plurality of switches SW1 to SWN. The switches SW1 to SWN is controlled to be turned on or turned off by a light tuning signal TUN.

Referring to FIG. 1 and FIG. 2, FIG. 2 illustrates waveforms of signals while the LED module 100 operates. Wherein, the light tuning signal TUN is a pulse signal. When the light tuning signal TUN is at a high voltage level during a period T1, the switches SW1 to SWN are turned on, so that the LED strings 171 to 173 are turned on. At this time, an under shoot Vripple1 is generated in the system voltage VOUT because the bandwidth of the system voltage VOUT is insufficient for response while the load thereof instantly change from no load to full load. On the contrary, when the light tuning signal TUN is at a low voltage level during a period T2, the switches SW1 to SWN are turned off, so that the LED strings 171 to 173 are turned off at the same time. An over shoot Vripple2 is generated in the system voltage VOUT while the load instantly change from full load to no load. While light tuning continuously works, the over shoots or the under shoots are constantly generated, so that the quality of the system voltage VOUT is reduced.

### SUMMARY OF THE INVENTION

An embodiment of the invention provides an LED module. Accordingly, while light of the LED module is tuned, ripples of the system voltage generated due to light tuning are reduced.

An embodiment of the invention provides a driving method of an LED module. Accordingly, while light of the LED module is tuned, ripples of the system voltage generated due to light tuning are reduced.

An embodiment of the invention provides an LED module. The LED module having a plurality of LED strings includes a voltage generating loop, a light tuner, a voltage selector, and a voltage storage and comparison circuit. The voltage generating loop is coupled to the LED strings and generates a system voltage according to a pulse modulation control signal. The light tuner is coupled to the LED strings for receiving a light tuning signal and turning on or off the LED strings according to the light tuning signal. The voltage selector is coupled to the light tuner and the LED strings together for selecting one of terminal voltages of terminals of the LED strings coupled to the light tuner to generate a selection voltage. The voltage storage and comparison circuit is coupled between the voltage selector and the voltage generating loop for comparing the selection voltage and a reference voltage to generate an error voltage. The voltage storage and comparison circuit temporarily stores the error voltage and provides the temporarily stored error voltage as the pulse modulation control signal.

In an embodiment of the invention, when the light tuner turns off the LED strings according to the light tuning signal, the voltage storage and comparison circuit stores the selection voltage.

In an embodiment of the invention, the voltage storage and comparison circuit includes a comparator and a sample and hold circuit. a comparator is coupled to the voltage selector to receive the selection voltage and compares the selection voltage and the reference voltage to generate the error voltage. The sample and hold circuit is coupled between the comparator and the voltage generating loop, and the sample and hold circuit temporarily stores the error voltage according to the light tuning signal to generate the pulse modulation control signal.

In an embodiment of the invention, the voltage selector selects the minimum one of the terminal voltages of the terminals of the LED strings coupled to the light tuner to generate the selection voltage.

In an embodiment of the invention, the light tuner includes a plurality of switches and a current driving device. Each of the switches is respectively coupled to each of the LED strings, and the switches are turned on or off according to the pulse modulation control signal. The current driving device is coupled the switches and determines whether to provide driving currents to the LED strings correspondingly coupled to the switches according to the switches turned on or off.

In an embodiment of the invention, the voltage generating loop includes a voltage converter and a pulse signal modulator. The voltage converter receives an input voltage and a pulse signal, and generates the system voltage by using the input voltage according to the pulse signal. The pulse signal modulator is coupled to the voltage converter and generates the pulse signal according to the pulse modulation control signal.

In an embodiment of the invention, each of the LED strings includes at least one LED. A positive terminal of the at least one LED is coupled to the system voltage, and a negative terminal thereof is coupled to the light tuner.

Another embodiment of the invention provides an LED module. The LED module having a plurality of LED strings includes a voltage generating loop, a light tuner, a voltage selector, and a voltage storage and comparison circuit. The voltage generating loop is coupled to the LED strings and generates a system voltage according to a pulse modulation control signal. The light tuner is coupled to the LED strings for receiving a light tuning signal and turning on or off the LED strings according to the light tuning signal. The voltage selector is coupled to the light tuner and the LED strings together for selecting one of terminal voltages of terminals of the LED strings coupled to the light tuner to generate a selection voltage. The voltage storage and comparison circuit is coupled between the voltage selector and the voltage generating loop. Wherein, the voltage storage and comparison circuit temporarily stores the selection voltage according to the light tuning signal, and generates the pulse modulation control signal by comparing the temporarily stored selection voltage and a reference voltage.

In an embodiment of the invention, the voltage storage and comparison circuit includes a comparator and a sample and hold circuit. The sample and hold circuit is coupled to the voltage selector to receive the selection voltage, and temporarily stores the selection voltage according to the light tuning signal. The comparator is coupled between the sample and hold circuit and the voltage generating loop, and compares the temporarily stored selection voltage and the reference voltage to generate the pulse modulation control signal.

An embodiment of the invention provides a driving method of an LED module, wherein the LED module includes a voltage generating loop, a voltage selector, and a voltage storage and comparison circuit, and the voltage generating loop generates a system voltage to drive the LED module. The driving method includes following steps. First of all, whether a light tuning start status of the LED module is activated is determined. When the light tuning start status is activated, it is determined that the LED module stays before or after a light tuning status according to a light tuning signal. When the light tuning start status is activated, and the LED module stays before the light tuning status, an error voltage generated by comparing a selection voltage and a reference voltage is temporarily stored through the voltage storage and comparison circuit, wherein the selection voltage is generated by the voltage selector. Next, When the light tuning start status is activated, and the LED module stays after the light tuning status, the temporarily stored error voltage is provided to the voltage generating loop through the voltage storage and comparison circuit.

In an embodiment of the invention, the driving method further includes a step of generating the system voltage according to the temporarily stored error voltage through the voltage generating loop.

In an embodiment of the invention, the driving method further includes a step of making the voltage generating loop to generate the stable system voltage before the step of “determining whether a light tuning start status of the LED module is activated”.

Another embodiment of the invention provides a driving method of an LED module, wherein the LED module includes a voltage generating loop, a voltage selector, and a voltage storage and comparison circuit, and the voltage generating loop generates a system voltage to drive the LED module. The driving method includes following steps. First of all, whether a light tuning start status of the LED module is activated is determined. When the light tuning start status is activated, it is determined that the LED module stays before or after a light tuning status according to a light tuning signal when the light tuning start status is activated, and the LED module stays before the light tuning status, a selection voltage generated by the voltage selector is temporarily stored through the voltage storage and comparison circuit. Next, when the light tuning start status is activated, and the LED module stays after the light tuning status, an error voltage is generated by comparing the temporarily stored selection voltage and a reference voltage through the voltage storage and comparison circuit.

Base on the above, in the embodiment of the invention, when the light tuning start status is activated, the status of the LED module is recorded through the temporarily stored selection voltage or error voltage before the light tuning status, and after the light tuning status, the recorded status of the LED module is restored. As a result, while light of the LED module is tuned, the ripples of the system voltage, resulting from constant turning on/off of the LED strings, are effectively reduced.

To make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a conventional LED module 100.

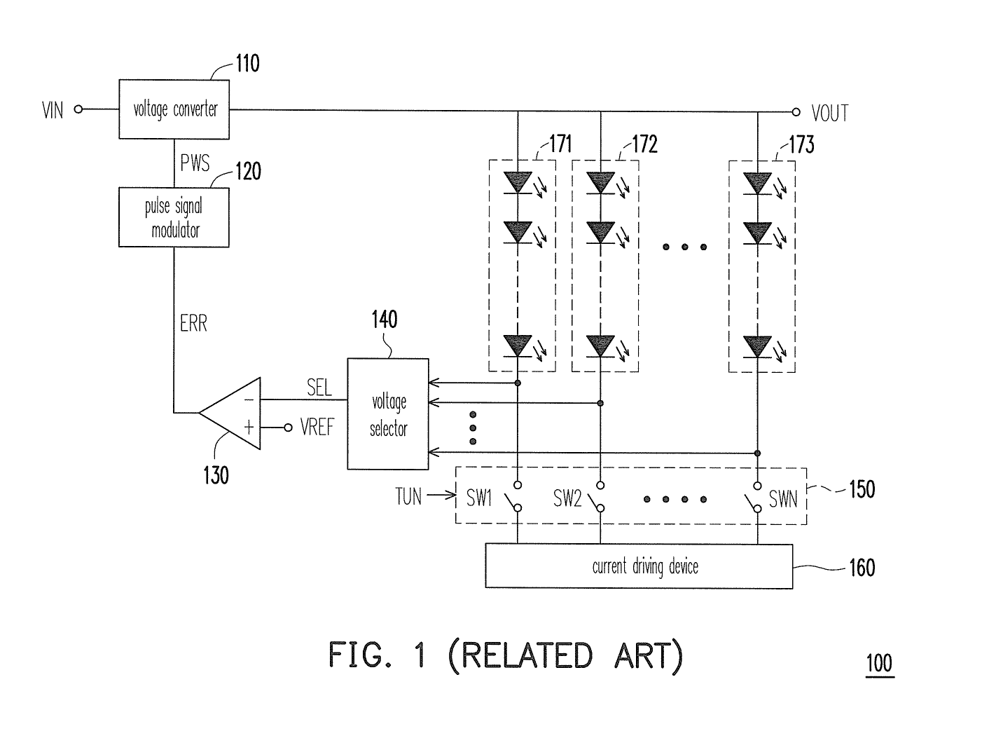

FIG. 2 illustrates waveforms of signals while the LED module 100 operates.

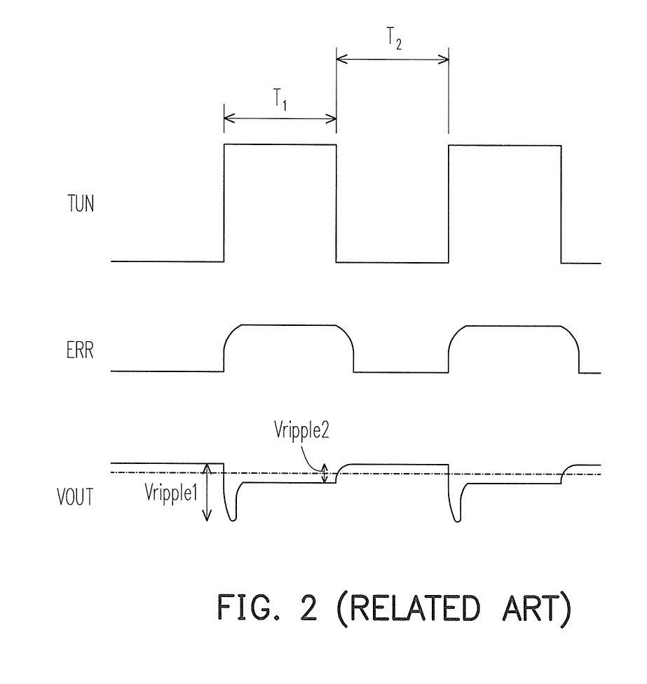

FIG. 3 is a schematic diagram of an LED module 300 according to an embodiment consistent with the invention.

FIG. 4 illustrates waveforms of signals while the LED module 300 operates.

FIG. 5 is a schematic diagram of an LED module 500 according to another embodiment consistent with the invention.

FIG. 6 is a flowchart of a driving method of the LED module according to an embodiment consistent with the invention.

FIG. 7 is a flowchart of a driving method of the LED module according to another embodiment consistent with the invention.

### DESCRIPTION OF EMBODIMENTS

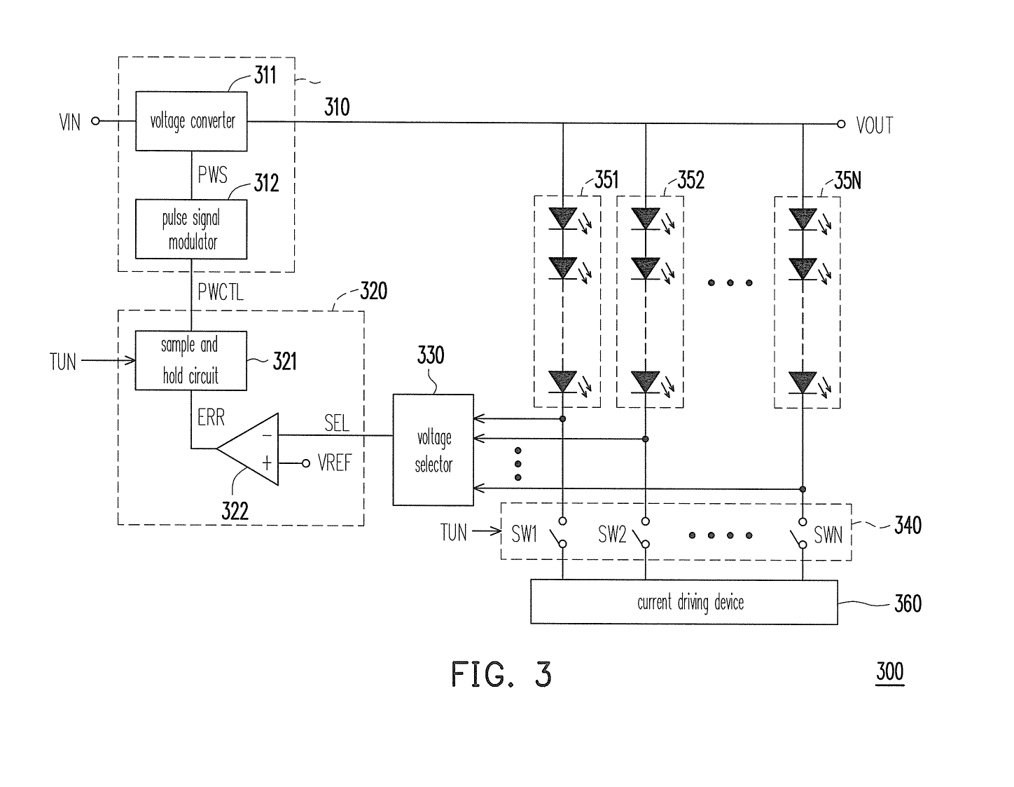

Referring to FIG. 3, FIG. 3 is a schematic diagram of an LED module 300 according to an embodiment consistent with the invention. The LED module 300 includes a voltage generating loop 310, a voltage storage and comparison circuit 320, a voltage selector 330, a light tuner 340, a plurality of LED strings 351, 352 to 35N, and a current driving device 360. The voltage generating loop 310 is coupled to the LED strings 351 to 35N, and the light tuner 340 is also coupled to the LED strings 351 to 35N. The voltage storage and comparison circuit 320 is coupled between the voltage generating loop 310 and the voltage selector 330, and the voltage selector 330 is coupled to the light tuner 340 and the LED strings 351 to 35N. Moreover, the current driving device 360 is coupled to the light tuner 340.

In the present embodiment, the voltage generating loop 310 receives an input voltage VIN and a pulse modulation control signal PWCTL and generates a system voltage VOUT according to the pulse modulation control signal PWCTL. Wherein, the voltage generating loop 310 includes a voltage converter 311 and a pulse signal modulator 312. The input voltage VIN is received through the voltage converter 311, and the pulse signal modulator 312 receives the pulse modulation control signal PWCTL to generate a pulse signal PWS, so that the pulse signal PWS is provided to the voltage converter 311 to serve as a basis to which the voltage converter 311 generates the system voltage VOUT according. Herein, the voltage converter 311 may be a DC/DC converter, and the DC/DC converter is well known to those skilled in the art, so that it will not be described in detail.

Each of the LED strings 351 to 35N is formed by connecting more than one LEDs in series. When the LED string is formed by one LED, the positive terminal of the LED is coupled to the system voltage VOUT, and the negative terminal thereof is coupled to the light tuner 340.

In the present embodiment, one terminal of each of the LED strings 351 to 35N receives the system voltage VOUT, and the other terminal of each of the LED strings 351 to 35N is coupled to the voltage selector 330 and the light tuner 340. The voltage selector 330 is configured to select one of terminal voltages of terminals of the LED strings 351 to 35N coupled thereto for generating a selection voltage SEL. For example, the voltage selector 330 may select the minimum one of the terminal voltages of the terminals of the LED strings 351 to 35N coupled thereto for generating the selection voltage SEL.

The light tuner receives a light tuning signal TUN and tunes brightness of the LED strings 351 to 35N according to the light tuning signal TUN. In the present embodiment, the light tuner 340 includes a plurality of switches SW1 to SWN. Each of the switches is respectively coupled between the current driving device 360 and each of the LED strings 351 to 35N. When the switches SW1 to SWN are turned on according to the light tuning signal TUN, the LED strings 351 to 35N are thus turned on. On the contrary, when the switches SW1 to SWN are turned off according to the light tuning signal TUN, the LED strings 351 to 35N are thus turned off.

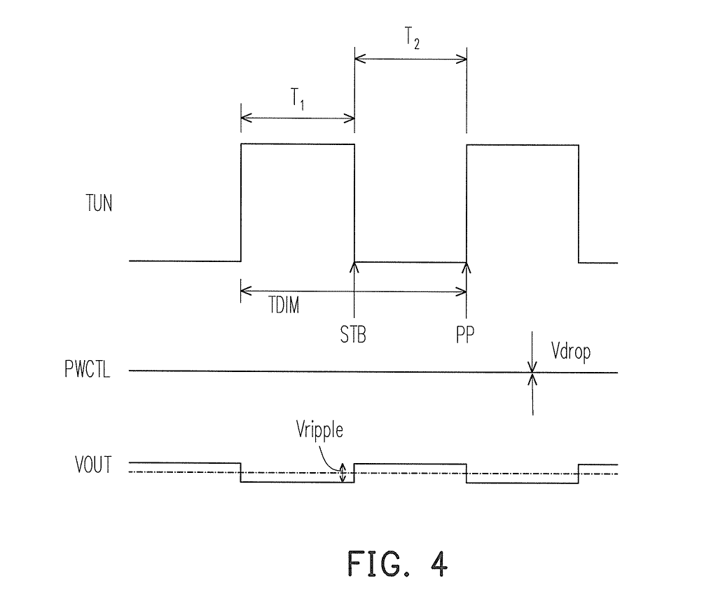

The voltage storage and comparison circuit 320 and the light tuner 340 both receive the light tuning signal TUN. The voltage storage and comparison circuit 320 operates according to the light tuning signal TUN when light of the LED module 300 is tuned. Herein, in order to describe the operation of the voltage storage and comparison circuit 320 in more detail, please refer to FIG. 3 and FIG. 4 at the same time, wherein FIG. 4 illustrates waveforms of signals while the LED module 300 operates. The voltage storage and comparison circuit 320 generates an error voltage ERR by comparing the selection voltage SEL and a reference voltage VREF. Moreover, when the LED module 300 enter a light tuning period TDIM, the voltage storage and comparison circuit 320 temporarily stores the error voltage ERR at a time point STB when the switches SW1 to SWN change from the ON state to the OFF state according to the light tuning signal TUN. Next, at a time point PP when the switches SW1 to SWN change from the OFF state to the ON state according to the light tuning signal TUN, the voltage storage and comparison circuit 320 provides the temporarily stored error voltage as the pulse modulation control signal PWCTL.

As a result, it is found that the pulse modulation control signal PWCTL has no voltage drop Vdrop when the switches SW1 to SWN switch between the ON state and the OFF state, therefore, the voltage drop Vripple of the system voltage VOUT is effectively reduced.

Please refer to FIG. 3 again. It should be noted that, the voltage storage and comparison circuit 320 includes a comparator 322 and a sample and hold circuit 321. Wherein, the comparator 322 executes the operation of comparing the selection voltage SEL and the reference voltage VREF to generate the error voltage ERR. Moreover, the sample and hold circuit 321 executes the operation of temporarily storing the error voltage ERR or providing the temporarily stored error voltage ERR as the pulse modulation control signal PWCTL according to the rising edge and the falling edge of the light tuning signal TUN.

Furthermore, the current driving device 360 is coupled to the light tuner 340. The current driving device 360 is configured to transmit driving currents to turn on the LED strings 351˜35N when the switches SW1 to SWN of the light tuner 340 is turned on.

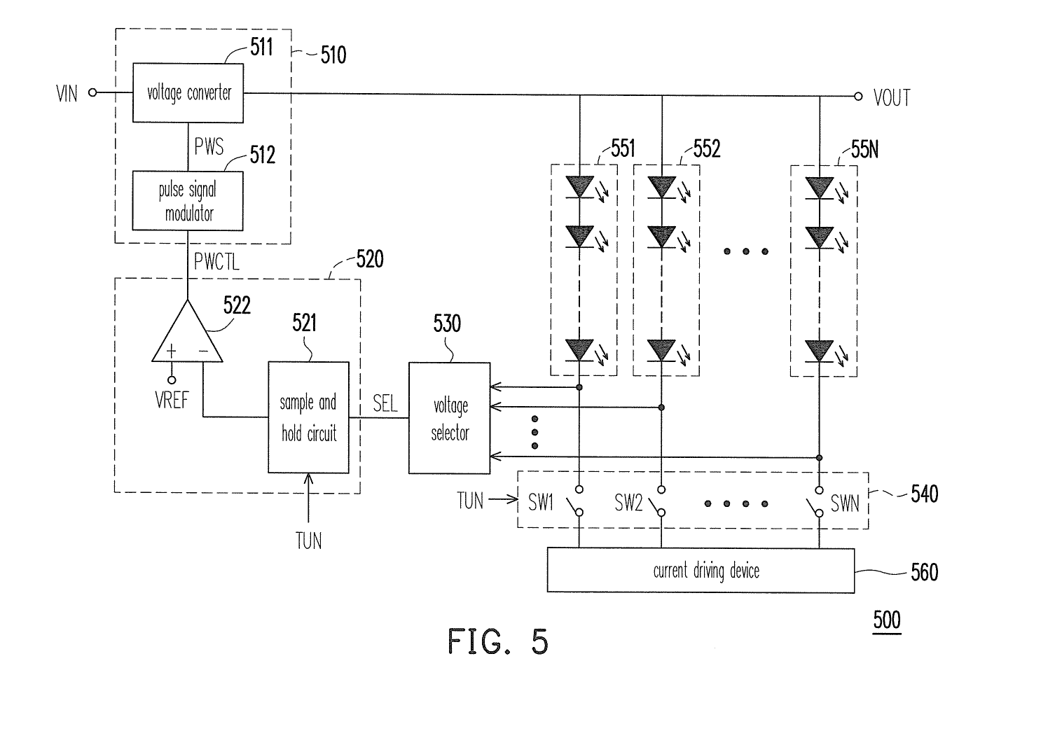

Referring to FIG. 5, FIG. 5 is a schematic diagram of an LED module 500 according to another embodiment consistent with the invention. The LED module 500 includes a voltage generating loop 510, a voltage storage and comparison circuit 520, a voltage selector 530, a light tuner 540, a plurality of LED strings 551, 552 to 55N, and a current driving device 560. The voltage generating loop 510 is coupled to the LED strings 551 to 55N, and the light tuner 540 is also coupled to the LED strings 551 to 55N. The voltage storage and comparison circuit 520 is coupled between the voltage generating loop 510 and the voltage selector 530, and the voltage selector 530 is coupled to the light tuner 540 and the LED strings 551 to 55N. Moreover, the current driving device 560 is coupled to the light tuner 540.

The voltage generating loop 510 is formed by a voltage converter 511 and a pulse signal modulator 512, and the light tuner 540 is formed by a plurality of switches SW1 to SWN. Moreover, the voltage storage and comparison circuit 520 is formed by a comparator 522 and a sample and hold circuit 521.

The difference of the LED module 500 from the LED module 300 is that, the sample and hold circuit 521 of the voltage storage and comparison circuit 520 in the LED module 500 is coupled to the voltage selector 530 and receives the selection voltage SEL, and the comparator 522 is coupled in series between the sample and hold circuit 521 and the voltage generating loop 510. In the present embodiment, the sample and hold circuit 521 temporarily stores the selection voltage SEL outputted by the voltage selector 530 according to the light tuning signal TUN at the moment when the switches SW1 to SWN change from the ON state to the OFF state. The sample and hold circuit 521 provides the temporarily stored selection voltage SEL to the comparator 522 at the moment when the switches SW1 to SWN change from the OFF state to the ON state according to the light tuning signal TUN. Next, through the comparator 522, the temporarily stored selection voltage SEL is compared with the reference voltage VREF to generate the pulse modulation control signal PWCTL.

It should be noted that, the voltage registered by the LED module 500 of the present embodiment is different from the voltage registered by the LED module 300 of the previous embodiment, but the two embodiments both provide the stable pulse modulation control signals PWCTL to the voltage generating loops correspondingly. Furthermore, the ripples of the system voltage VOUT generated by the voltage generating loop are effectively reduced.

Next, for the driving method of the LED module, embodiments thereof will be further described, so that those with ordinary skills of the art can have a better understanding and are capable of implementation.

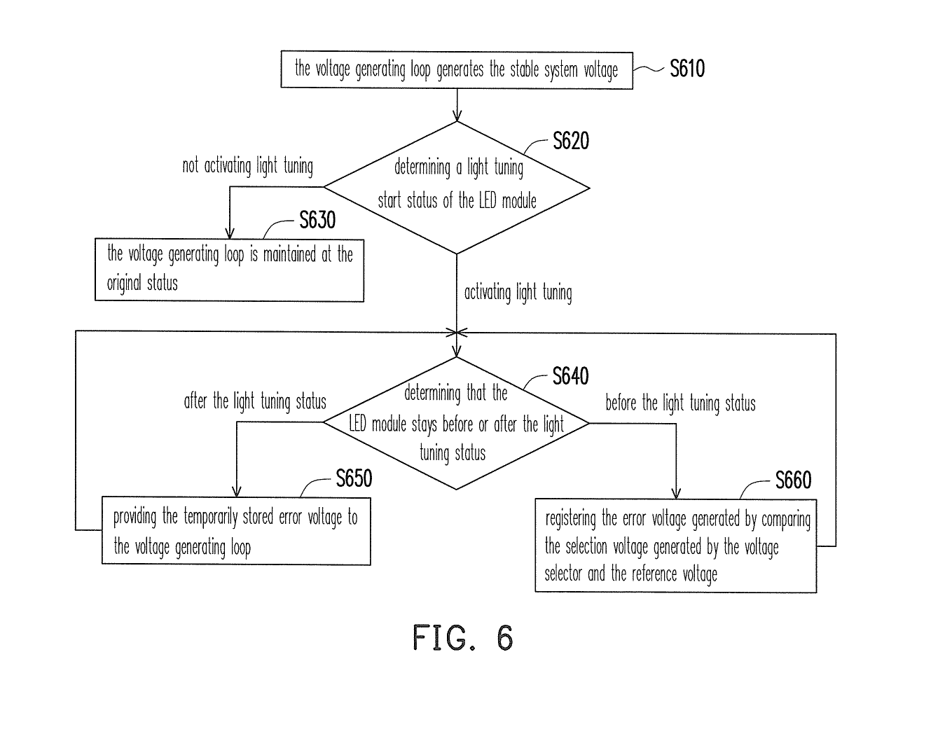

Referring to FIG. 6, FIG. 6 is a flowchart of a driving method of the LED module according to an embodiment consistent with the invention. The driving method includes following steps. First of all, the voltage generating loop is made to generate the stable system voltage (step S610). Generally, it requires a waiting period to generate the system voltage because the voltage generating loop requires a higher voltage to drive the LED module. Through the system voltage generated by the voltage generating loop after the waiting period, the LED module can simply provide a stable and good performance of light emitting. Next, a light tuning start status of the LED module is determined (step S620). In other words, whether the light tuning operation of the LED module is activated is checked. If the light tuning operation of the LED module is not activated, the voltage generating loop simply requires being maintained at the original status (step S630). That is, the LED module is maintained in the original operation.

Alternatively, if the light tuning operation of the LED module is activated, a light tuning status of the LED module is determined according to the light tuning signal (step S640). Herein, the so-called tuning status means that the LED module stays before or after the light tuning status. In the LED module 300, when the light tuning signal TUN changes from a high voltage level to a low voltage level, it means that the LED module stays before the light tuning status. On the contrary, when the light tuning signal TUN changes from the low voltage level to the high voltage level, it means that the LED module stays after the light tuning status.

If it is determined that the LED module stays before the light tuning status, the error voltage is registered (step S660). Wherein, the error voltage is obtained by comparing the selection voltage and the reference voltage. In the LED module 300, the selection voltage is generated by the voltage selector 330. The operation of comparing the selection voltage and the reference voltage is implemented by the comparator 322.

Alternatively, if it is determined that the LED module stays after the light tuning status, the temporarily stored error voltage is provided to the voltage generating loop (step S650). It should be noted that, steps S660 and 5650 can be alternately executed repeatedly until the light tuning operation of the LED module 300 is turned off.

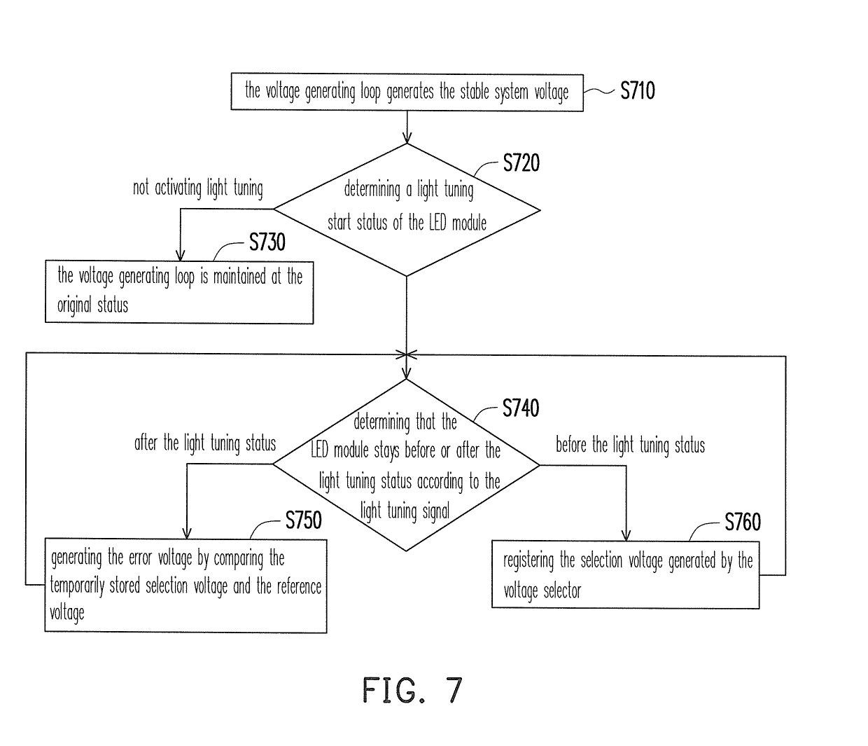

Referring to FIG. 7, FIG. 7 is a flowchart of a driving method of the LED module according to another embodiment consistent with the invention. The driving method includes following steps. First of all, the voltage generating loop is made to generate the stable system voltage (step S710). Next, the light tuning start status of the LED module is determined (step S720). If the light tuning operation of the LED module is not activated, the voltage generating loop simply requires being maintained at the original status (step S730), and if the light tuning operation of the LED module is activated, the light tuning status of the LED module is determined according to the light tuning signal (step S740).

The difference of the driving method of the LED module in the present embodiment from the driving method in the previous embodiment is that, if it is determined that the LED module stays before the light tuning status, the selection voltage is registered (step S760). If it is determined that the LED module stays after the light tuning status, the error voltage is generated by comparing the temporarily stored selection voltage and the reference voltage (step S750), and the error voltage is provided as the pulse modulation control signal of the voltage generating loop.

Moreover, steps S760 and S750 can be alternately executed repeatedly until the light tuning operation of the LED module is turned off.

To sum up, in the embodiment of the invention, the temporarily stored selection voltage or error voltage servers as the pulse modulation control signal of the LED module after light tuning. Accordingly, the pulse modulation control signal is stabilized, and further, the system voltage generated by the voltage generating loop is also stabilized.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A light emitting diode (LED) module, having a plurality of LED strings, comprising:
a voltage generating loop coupled to the LED strings, and the voltage generating loop generating a system voltage according to a pulse modulation control signal;
a light tuner coupled to the LED strings, and the light tuner receiving a light tuning signal and turning on or off the LED strings according to the light tuning signal;
a voltage selector coupled to the light tuner and the LED strings together, and the voltage selector selecting one of terminal voltages of terminals of the LED strings coupled to the light tuner to generate a selection voltage; and
a voltage storage and comparison circuit coupled between the voltage selector and the voltage generating loop, and the voltage storage and selection circuit comparing the selection voltage and a reference voltage to generate an error voltage, wherein the voltage storage and comparison circuit temporarily stores the error voltage and provides the temporarily stored error voltage as the pulse modulation control signal.

2. The LED module as claimed in claim 1, wherein the voltage storage and comparison circuit stores the selection voltage when the light tuner turns off the LED strings according to the light tuning signal.

3. The LED module as claimed in claim 1, wherein the voltage storage and comparison circuit comprises:
a comparator coupled to the voltage selector to receive the selection voltage, and the comparator comparing the selection voltage and the reference voltage to generate the error voltage; and
a sample and hold circuit coupled between the comparator and the voltage generating loop, and the sample and hold circuit temporarily storing the error voltage according to the light tuning signal to generate the pulse modulation control signal.

4. The LED module as claimed in claim 1, wherein the voltage selector selects the minimum one of the terminal voltages of the terminals of the LED strings coupled to the light tuner to generate the selection voltage.

5. The LED module as claimed in claim 1, wherein, wherein the light tuner comprises:
a plurality of switches, each of the switches respectively coupled to each of the LED strings, and the switches turned on or off according to the pulse modulation control signal; and
a current driving device coupled the switches, and the current driving device determining whether to provide driving currents to the LED strings correspondingly coupled to the switches according to the switches turned on or off.

6. The LED module as claimed in claim 1, wherein the voltage generating loop comprises:
a voltage converter receiving an input voltage and a pulse signal, and the voltage converter generating the system voltage by using the input voltage according to the pulse signal; and
a pulse signal modulator coupled to the voltage converter, and the pulse signal modulator generating the pulse signal according to the pulse modulation control signal.

7. The LED module as claimed in claim 1, wherein each of the LED strings comprises:
at least one LED having a positive terminal coupled to the system voltage and a negative terminal coupled to the light tuner.

8. An LED module, having a plurality of LED strings, comprising:
a voltage generating loop coupled to the LED strings, and the voltage generating loop generating a system voltage according to a pulse modulation control signal;
a light tuner coupled to the LED strings, and the light tuner receiving a light tuning signal and turning on or off the LED strings according to the light tuning signal;
a voltage selector coupled to the light tuner and the LED strings together, and the voltage selector selecting one of terminal voltages of terminals of the LED strings coupled to the light tuner to generate a selection voltage; and
a voltage storage and comparison circuit coupled between the voltage selector and the voltage generating loop, wherein the voltage storage and comparison circuit temporarily stores the selection voltage according to the light tuning signal and generates the pulse modulation control signal by comparing the temporarily stored selection voltage and a reference voltage.

9. The LED module as claimed in claim 8, wherein the voltage storage and comparison circuit stores the selection voltage when the light tuner turns off the LED strings according to the light tuning signal.

10. The LED module as claimed in claim 8, wherein the voltage storage and comparison circuit comprises:
a sample and hold circuit coupled to the voltage selector to receive the selection voltage, and the sample and hold circuit temporarily storing the selection voltage according to the light tuning signal; and
a comparator coupled between the sample and hold circuit and the voltage generating loop, and the comparator comparing the temporarily stored selection voltage and the reference voltage to generate the pulse modulation control signal.

11. The LED module as claimed in claim 8, wherein the voltage selector selects the minimum one of the terminal voltages of the terminals of the LED strings coupled to the light tuner to generate the selection voltage.

12. The LED module as claimed in claim 8, wherein, wherein the light tuner comprises:
a plurality of switches, each of the switches respectively coupled to each of the LED strings, and the switches turned on or off according to the pulse modulation control signal; and
a current driving device coupled the switches, and the current driving device determining whether to provide driving currents to the LED strings correspondingly coupled to the switches according to the switches turned on or off.

13. The LED module as claimed in claim 8, wherein the voltage generating loop comprises:
a voltage converter receiving an input voltage and a pulse signal, and the voltage converter generating the system voltage by using the input voltage according to the pulse signal; and
a pulse signal modulator coupled to the voltage converter, and the pulse signal modulator generating the pulse signal according to the pulse modulation control signal.

14. The LED module as claimed in claim 8, wherein each of the LED strings comprises:
at least one LED having a positive terminal coupled to the system voltage and a negative terminal coupled to the light tuner.

15. A driving method of an LED module, the LED module comprising a voltage generating loop, a voltage selector, and a voltage storage and comparison circuit, wherein the voltage generating loop generates a system voltage to drive the LED module, the driving method comprising:
determining whether a light tuning start status of the LED module is activated;
determining that the LED module stays before or after a light tuning status according to a light tuning signal when the light tuning start status is activated;
temporarily storing an error voltage generated by comparing a selection voltage and a reference voltage through the voltage storage and comparison circuit when the light tuning start status is activated, and the LED module stays before the light tuning status, wherein the selection voltage is generated by the voltage selector; and
providing the temporarily stored error voltage to the voltage generating loop through the voltage storage and comparison circuit when the light tuning start status is activated, and the LED module stays after the light tuning status.

16. The driving method as claimed in claim 15, further comprising:
generating the system voltage according to the temporarily stored error voltage through the voltage generating loop.

17. The driving method as claimed in claim 15, before the step of “determining whether a light tuning start status of the LED module is activated”, the driving method further comprising:
making the voltage generating loop to generate the stable system voltage.

18. A driving method of an LED module, the LED module comprising a voltage generating loop, a voltage selector, and a voltage storage and comparison circuit, wherein the voltage generating loop generates a system voltage to drive the LED module, the driving method comprising:
determining whether a light tuning start status of the LED module is activated;
determining whether the LED module stays before or after a light tuning status according to a light tuning signal when the light tuning start status is a start status;
temporarily storing a selection voltage generated by the voltage selector through the voltage storage and comparison circuit when the light tuning start status is activated, and the LED module stays before the light tuning status; and
generating an error voltage by comparing the temporarily stored selection voltage and a reference voltage through the voltage storage and comparison circuit when the light tuning start status is activated, and the LED module stays after the light tuning status.

19. The driving method as claimed in claim 18, further comprising:
generating the system voltage according to the temporarily stored selection voltage through the voltage generating loop.

20. The driving method as claimed in claim 18, before the step of “determining whether a light tuning start status of the LED module is activated”, the driving method further comprising:
making the voltage generating loop to generate the stable system voltage.
